(19) United States
(12) Patent Application Publication
(10) Pub. No.: US 2026/0279943 A1
(43) Pub. Date: Sep. 17, 2026

(54) TREATMENT METHOD FOR WASTE SOLID-STATE BATTERY

(71) Applicant: HONDA MOTOR CO., LTD., Tokyo (JP)

(72) Inventors: Satoru TAKAHASHI, Saitama (JP); Yushi FUJINAGA, Saitama (JP); Mitsumasa SORAZAWA, Saitama (JP); Takayuki SAKATA, Saitama (JP)

(21) Appl. No.: 19/561,539

(22) Filed: Mar. 10, 2026

(30) Foreign Application Priority Data
Mar. 11, 2025 (JP) 2025-037993

(51) Int. Cl. H01M 10/54; B09B 3/80; B09B 101/16

(52) U.S. Cl. CPC H01M 10/54; B09B 3/80; B09B 2101/16

(57) ABSTRACT

There can be provided a treatment method of separating a positive electrode and a negative electrode in a short time. Provided is a treatment method for a waste solid-state battery 100 that includes a solid electrolyte 10 and a negative electrode material 12, and at least one selected from them is water-soluble. The method includes a step of immersing an electrode assembly of the waste solid-state battery 100 in water, and a step of reducing a pressure of a surrounding environment of the water.

### CROSS-REFERENCE TO RELATED APPLICATION

This application is based on and claims the benefit of priority from Japanese Patent Application No. 2025-037993, filed on 11 Mar. 2025, the content of which is incorporated herein by reference.

### BACKGROUND OF THE INVENTION

### Field of the Invention

The present invention relates to a treatment method for a waste solid-state battery, and, more particularly, to a method of separating a positive electrode and a negative electrode of a solid-state battery.

### Related Art

From viewpoint of effective utilization of resources, recycling of solid-state batteries has been studied. For example, Japanese Unexamined Patent Application, Publication No. 2024-140716 discloses a treatment method of separating positive and negative electrodes by applying an electrical pulse to the electrodes after deactivating lithium, which is a negative electrode material, by way of reaction of lithium with water.

Patent Document 1: Japanese Unexamined Patent Application, Publication No. 2024-140716

### SUMMARY OF THE INVENTION

Among conventional treatment methods of separating positive and negative electrodes, for example, a method includes immersing, in water, an electrode assembly in which positive and negative electrodes are laminated, thereby separating the positive and negative electrodes. This method has a disadvantage that time is required for the separation. In a case where the electrode assembly is immersed in water for a long time, there is another disadvantage that current collector foils are likely to be damaged, in addition to the time required for treatment of them.

The present invention has an object to provide a treatment method of separating a positive electrode and a negative electrode in a short time. In particular, the present invention has an object to provide a treatment method of separating a positive electrode and a negative electrode in a short time by immersing, in water, a solid-state battery in which the positive electrode and the negative electrode are laminated so that lithium metal and a solid electrolyte are dissolved in the water.

(1) A treatment method for a waste solid-state battery that includes a solid electrolyte and a negative electrode material, and at least one selected from the solid electrolyte and the negative electrode material is water-soluble and generates gas when immersed in water, the method including a step of immersing an electrode assembly of the waste solid-state battery in water, and a step of reducing a pressure of a surrounding environment of the water.

(2) The treatment method for a waste solid-state battery, in which the solid electrolyte includes at least one selected from a water-soluble sulfide and a water-soluble oxide.

(3) The treatment method for a waste solid-state battery, in which the negative electrode material includes at least one selected from lithium metal, sodium metal, potassium metal, magnesium metal, calcium metal, a lithium titanium oxide, a carbon material, and silicon.

(4) The treatment method for a waste solid-state battery, in which the negative electrode material is lithium metal or sodium metal, and the waste solid-state battery in a state before the negative electrode material is deactivated is immersed in water.

According to the present invention, there can be provided a treatment method of separating a positive electrode and a negative electrode in a short time in a solid-state battery.

### BRIEF DESCRIPTION OF THE DRAWINGS

FIG. 1 is a diagram illustrating an outline of a recycling process of a solid-state battery;

FIG. 2A is a diagram illustrating a state of the solid-state battery immersed in water in a treatment method for a waste solid-state battery of the present embodiment;

FIG. 2B is a diagram illustrating a state of the solid-state battery immersed in water in the treatment method for a waste solid-state battery;

FIG. 3 is a perspective view of a processing device used in a positive and negative electrode separation step; and

FIG. 4 is a flowchart illustrating a flow of the treatment method for a waste solid-state battery of the present embodiment.

### DETAILED DESCRIPTION OF THE INVENTION

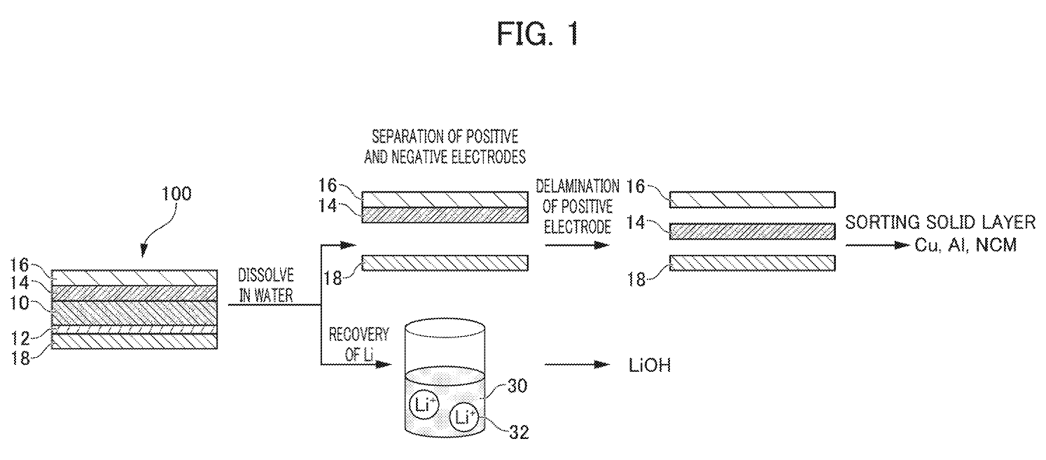

A treatment method for a solid-state battery 100 in an embodiment of the present invention will be described with reference to the drawings. FIG. 1 is a diagram illustrating an outline of a recycling process of the solid-state battery 100. Here, the solid-state battery 100 means particularly an electrode assembly included in the solid-state battery 100. First, a cell material constituting the electrode assembly of the solid-state battery 100 will be described.

### Configuration of Solid-state Battery

The solid-state battery 100 has a structure in which a solid electrolyte is sandwiched between current collector foils. In the example illustrated in FIG. 1, the solid-state battery 100 includes an aluminum foil 16 and a copper foil 18 as the current collector foils. A positive electrode material, a solid electrolyte, and a negative electrode material are disposed between the aluminum foil 16 and the copper foil 18.

In the example illustrated in FIG. 1, the positive electrode material is a nickel-cobalt-manganese (NCM) oxide material. The negative electrode material is lithium metal. A sulfide solid electrolyte 10 is a material containing sulfide. Specific examples of such a material include a compound such as Li₃PS₄, Li₆PS₅Cl, Li₆PS₅Br, or Li₇P₃S₁₁. A positive electrode material layer formed of NCM is represented as an NCM 14, a negative electrode material layer formed of lithium metal is represented as lithium metal 12, and a solid electrolyte layer formed of a material containing sulfide is represented as the sulfide solid electrolyte 10.

The solid-state battery 100 illustrated in FIG. 1 is configured by laminating the aluminum foil 16, the NCM 14, the sulfide solid electrolyte 10, the lithium metal 12, and the copper foil 18 in this order.

However, the above-described configuration of the solid-state battery 100 is an example. The material of each part constituting the solid-state battery 100 can be variously changed. Instead of the sulfide, an oxide, or an organic polymer compound can be used as the solid electrolyte. Instead of the lithium metal, sodium metal, potassium metal, magnesium metal, calcium metal, a lithium titanium oxide (for example, Li₄Ti₅O₁₂), a carbon material (carbon), or silicon can be used as the negative electrode material.

Note that, in the solid-state battery 100 of the present embodiment, at least one selected from the solid electrolyte and the negative electrode material is a water-soluble material.

### Recycling Process

An outline of the recycling process of the solid-state battery 100 will be described with reference to FIG. 1. The solid-state battery 100 to be subjected to the recycling process is referred to as a waste solid-state battery. The recycling process includes a positive and negative electrode separation step, a positive electrode delamination step, a lithium recovery step, and a solid phase sorting step.

The positive and negative electrode separation step is a step of separating the positive electrode material and the negative electrode material. The separation of the positive electrode material and the negative electrode material is performed in the water. In the positive and negative electrode separation step, the entire solid-state battery 100 is immersed in water 30. In particular, when the negative electrode material is lithium metal, the solid-state battery 100 is immersed in the water in a state before the lithium metal is deactivated.

In this way, among components constituting the solid-state battery 100, soluble components are dissolved in the water 30. In the example illustrated in FIG. 1, the sulfide solid electrolyte 10 and the lithium metal 12 which are water-soluble are dissolved in the water 30. The lithium metal 12 is dissolved in the water 30, so that lithium ions 32 are generated.

On the other hand, the aluminum foil 16, the NCM 14, and the copper foil 18 which are not water-soluble remain in the water 30 as they are. This makes it possible to separate the NCM 14 which is the positive electrode material and the lithium metal 12 which is the negative electrode material.

In the treatment method for a waste solid-state battery of the present embodiment, in the positive and negative electrode separation step, a pressure of the surrounding environment of the water 30 in which the solid-state battery 100 is immersed is reduced. The water 30 in which the solid-state battery 100 is immersed is defined as immersion water 30. In the present embodiment, the immersion water 30 is placed under a reduced pressure environment. The details of pressure reduction will be described later.

The positive electrode delamination step is a step of delaminating the positive electrode material from the current collector foil. The delamination of the positive electrode material from the current collector foil is performed after the positive electrode and the current collector foil are taken out from the immersion water 30. In the positive electrode delamination step, the NCM 14 which is the positive electrode material is separated from the aluminum foil 16 which is the current collector foil.

The solid phase sorting step is a step of sorting and recovering a metal constituting each of the separated current collector foils and NCM 14. Specifically, aluminum, a nickel-cobalt-manganese oxide , and copper are recovered from the aluminum foil 16, the NCM 14, and the copper foil 18, respectively. The sorting and recovery of each metal can be performed using a well-known solid phase sorting technology.

The lithium recovery step is a step of recovering lithium hydroxide from lithium ions dissolved in the water.

### Positive and Negative Electrode Separation Step

In the treatment method for a waste solid-state battery of the present embodiment, the positive and negative electrode separation step is particularly characteristic among the above-described recycling process of the solid-state battery 100. The positive and negative electrode separation step will be described in more detail below.

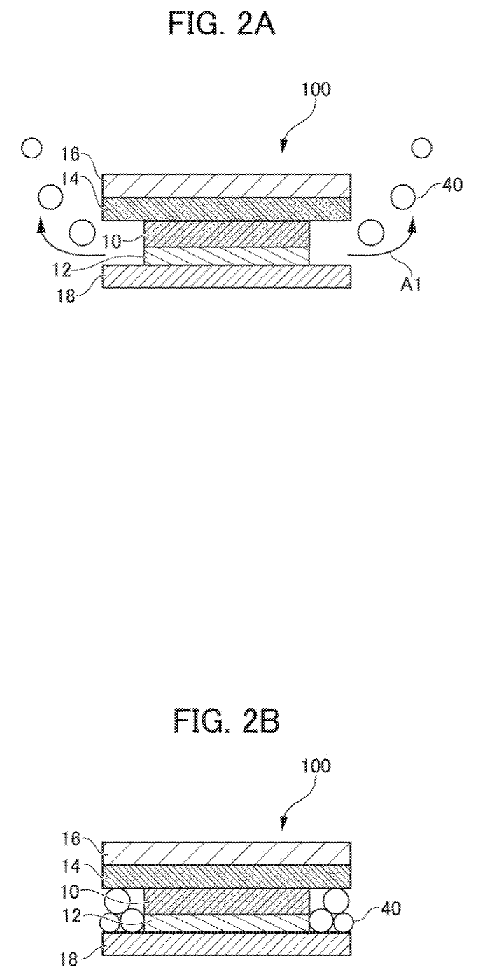

In the treatment method for a waste solid-state battery of the present embodiment, the immersion water 30 which is water in the solid-state battery 100 is immersed is placed under the reduced pressure environment as described above. This makes it possible to, in the positive and negative electrode separation step, reduce the time required for this step and reduce damage to the current collector foils. Furthermore, this makes it possible to prevent foreign matters from entering the recovered materials and to reduce a decrease in purity of the recovered materials. Hereinafter, the description will be made with reference to FIGS. 2A and 2B.

FIG. 2A is a diagram illustrating a state of the solid-state battery 100 immersed in the immersion water 30 in the treatment method for a waste solid-state battery of the present embodiment. In FIG. 2A, the immersion water 30 is placed under the reduced pressure.

FIG. 2B is a diagram illustrating a state of the solid-state battery 100 immersed in the water. In FIG. 2B, the immersion water 30 is placed not under the reduced pressure but under an atmospheric pressure.

Note that the immersion water 30 is not illustrated in FIGS. 2A and 2B. In FIGS. 2A and 2B, a direction from the copper foil 18 toward the aluminum foil 16 is a direction toward a water surface, that is, an upward direction.

As illustrated in FIG. 2A, the lithium metal 12 immersed in the water generates hydrogen gas when reacting with the water to be dissolved in the water. The sulfide solid electrolyte 10 immersed in the water generates hydrogen sulfide gas when reacting with the water to be dissolved in the water. The generated hydrogen and hydrogen sulfide become bubbles 40 in the water. In the present embodiment, the immersion water 30 is placed under the reduced pressure. Therefore, the bubbles 40 generated from the lithium metal 12 and the sulfide solid electrolyte 10 are likely to move in the direction toward the water surface as indicated by arrows A1.

Since the immersion water 30 is placed under the reduced pressure, the bubbles 40 generated from the lithium metal 12 and the sulfide solid electrolyte 10 expand. Therefore, the generated bubbles 40 are likely to move in the direction toward the water surface as indicated by the arrows A1.

As a result, the bubbles 40 are likely to be removed from the vicinity of the surfaces of the lithium metal 12 and the sulfide solid electrolyte 10. When the bubbles 40 are removed from the vicinity of the surface of the lithium metal 12, new water is likely to be supplied to the surfaces of the lithium metal 12 and the sulfide solid electrolyte 10, so that the dissolution of the lithium metal 12 and the sulfide solid electrolyte 10 in the water is promoted. That is, since the chance of the surfaces of the lithium metal 12 and the sulfide solid electrolyte 10 contacting the new water is increased, so that the dissolution of the lithium metal 12 in the water is promoted.

In other hand, as illustrated in FIG. 2B, when the immersion water 30 is placed under the atmospheric pressure, the bubbles generated from the lithium metal 12 and the sulfide solid electrolyte 10 are likely to stay in the vicinity of the lithium metal 12 and the sulfide solid electrolyte 10. In particular, in a case where the thicknesses of the lithium metal 12 and the sulfide solid electrolyte 10 are relatively thin, and a distance between the NCM 14 and the copper foil 18 is short, the bubbles 40 generated from the lithium metal 12 and the sulfide solid electrolyte 10 are likely to stay between the NCM 14 and the copper foil 18. In a case where the bubbles 40 stay in the vicinity of the lithium metal 12, the chance of the surfaces of the lithium metal 12 and the sulfide solid electrolyte 10 contacting the new water is reduced. Therefore, the dissolution of the lithium metal 12 and the sulfide solid electrolyte 10 in the water is reduced, and thus, the positive and negative electrode separation is inhibited by the bubbles 40.

The pressure after de-pressurization is not limited to a particular pressure. Here, the pressure is, for example, a pressure in a pressure container 210 to be described later. The pressure after de-pressurization can be, for example, a pressure lower than the atmospheric pressure by 0.08 MPa or more. This can promote generation of bubbles, and can increase a generation rate of bubbles. The pressure after de-pressurization can be preferably a pressure lower than the atmospheric pressure by 0.08 MPa or more and 0.095 MPa or less.

### Damage to Current Collector Foils

The damage to the current collector foils will be described. In the treatment method for a waste solid-state battery of the present embodiment, the dissolution of the lithium metal 12 in the immersion water 30 is promoted, so that the time required for the positive and negative electrode separation step can be reduced. This can reduce the damage to the current collector foils.

### Aluminum Foil

When the sulfide solid electrolyte 10 and the lithium metal 12 are dissolved in the immersion water 30, the immersion water 30 becomes strongly alkaline. The aluminum foil 16 out of the current collector foils is dissolved in an alkali aqueous solution. Therefore, when the time is required for the positive and negative electrode separation step, and the time to immerse the aluminum foil 16 in the immersion water 30 is long, the aluminum foil 16 is likely to be damaged. In addition, when the aluminum foil 16 is dissolved in the immersion water 30, the purity of the recovered materials is likely to decrease.

In this regard, in the treatment method for a waste solid-state battery of the present embodiment, the time required for the positive and negative electrode separation step can be reduced by performing the positive and negative electrode separation step under the reduced pressure. Therefore, the time to immerse the aluminum foil 16 in the immersion water 30 is reduced. As a result, it is possible to reduce the damage to the aluminum foil 16, and to reduce a decrease in purity of the recovered materials.

### Copper Foil

The immersion water 30 includes hydrogen sulfide by dissolving the sulfide solid electrolyte 10 in the immersion water 30. When the copper foil 18 out of the current collector foils contacts the water containing hydrogen sulfide, the copper is sulfurized. When being sulfurized, the copper becomes brittle.

Therefore, when the time is required for the positive and negative electrode separation step, and the time to immerse the copper foil 18 in the water is long, the copper foil 18 becomes brittle, so that the copper foil 18 is likely to be damaged. When the brittle copper foil 18 is chipped and diffused in the water, the purity of the recovered materials is likely to decrease.

In this regard, in the treatment method for a waste solid-state battery of the present embodiment, the time required for the positive and negative electrode separation step can be reduced by performing the positive and negative electrode separation step under the reduced pressure. Therefore, the time to immerse the copper foil 18 in the immersion water 30 is reduced. As a result, it is possible to prevent the copper foil 18 from being easily damaged due to the brittleness of the copper foil 18, and to reduce a decrease in purity of the recovered materials.

### Stirring

In the positive and negative electrode separation step, stirring the immersion water 30, and applying ultrasonic vibrations to the immersion water 30 lead to the promotion of the positive and negative electrode separation. This is because the bubbles 40 are likely to be removed from the vicinity of the surfaces of the lithium metal 12 and the sulfide solid electrolyte 10. Note that in the following description, stirring the immersion water 30, or applying ultrasonic vibrations to the immersion water 30 is referred to as "stirring the immersion water 30, or the like".

As described above, in the positive and negative electrode separation step, stirring the immersion water 30, or the like is preferable in terms of positive and negative electrode separation promotion.

On the other hand, stirring the immersion water 30, or the like causes a physical external force to be applied to the current collector foils. When the physical external force is applied to the current collector foils, the current collector foils are likely to be damaged. Therefore, when stirring the immersion water 30, or the like is performed, the degrees of stirring or the like is preferably adjusted in consideration of the damage to the current collector foils. The degrees refer to the strength, the speed, the time, and the like of the stirring or the like.

### Processing Device

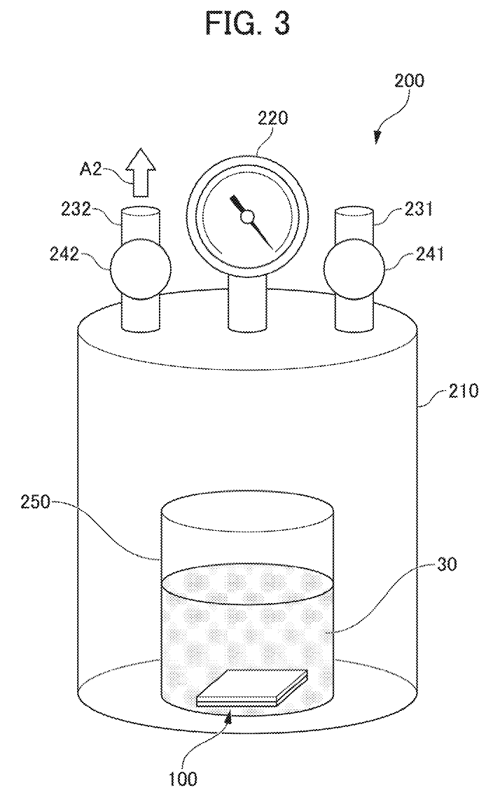

An example of a processing device 200 used in the positive and negative electrode separation step will be described with reference to FIG. 3. FIG. 3 is a perspective view of the processing device 200 schematically illustrating an example of the processing device 200.

The processing device 200 includes the pressure container 210, an intake pipe 231, an exhaust pipe 232, an intake valve 241, an exhaust valve 242, and a pressure gauge 220. The pressure container 210 is a container that has a cavity formed inside and whose internal pressure can be reduced. FIG. 3 illustrates a state of the inside of the pressure container 210 in a transparent view to show the state of the inside of the pressure container 210. The pressure container 210 can be formed of a transparent material such as glass. The pressure container 210 preferably has corrosion resistance. A reaction container 250 is placed inside the pressure container 210.

The intake pipe 231 and the exhaust pipe 232 are provided in the pressure container 210. The intake valve 241 is provided to the intake pipe 231, and the exhaust valve 242 is provided to the exhaust pipe 232. A pump (not illustrated) is connected to the exhaust pipe 232.

The pressure gauge 220 is provided on the pressure container 210. The pressure gauge 220 can measure a pressure inside the pressure container 210.

In the inside of the pressure container 210, the intake valve 241 is closed, the exhaust valve 242 is opened, and the pump is operated, so that the pressure can be reduced. The pressure inside the pressure container 210 can be checked by the pressure gauge 220.

The water is injected into the reaction container 250, and the solid-state battery 100 is immersed in the water.

In the positive and negative electrode separation step, the solid-state battery 100 is immersed in the reaction container 250 containing the water. Then, the pressure inside the pressure container 210 is reduced by the pump connected to the exhaust pipe 232. Thus, the water in which the solid-state battery 100 is immersed, that is, the immersion water 30 is placed under the reduced pressure environment.

When the positive and negative electrode separation is completed, the reduction in pressure inside the pressure container 210 is completed, and the inside of the pressure container 210 is returned to the atmospheric pressure. This completes the positive and negative electrode separation step. The completion of the positive and negative electrode separation can be detected, for example, when the generation of the bubbles from the lithium metal 12 or the sulfide solid electrolyte 10 is completed.

Note that the processing device 200 illustrated in FIG. 3 is an example. The shape of the pressure container 210 is not limited to a cylindrical shape illustrated in FIG. 3. The shape of the pressure container 210 may be, for example, a cube shape. Similarly, the shape of the reaction container 250 is not limited to a cylindrical beaker shape illustrated in FIG. 3. The shape of the reaction container 250 may be, for example, a cube shape.

### Flow of Processing

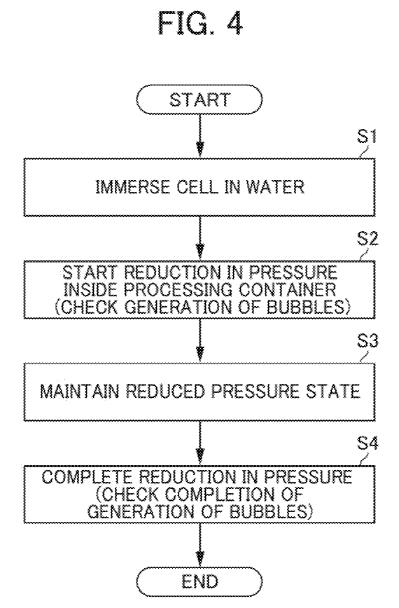

A flow of processing of the positive and negative electrode separation step in the treatment method for a waste solid-state battery of the present embodiment will be described with reference to FIG. 4. FIG. 4 is a flowchart illustrating a flow of the treatment method for a waste solid-state battery of the present embodiment. In FIG. 4 and the following description, S1 shows step 1. The same applies to S2 and subsequent steps.

### S1

S1 is a step in which a cell is immersed in water. In S1, a waste solid-state battery which is the solid-state battery 100 to be subjected to recycling is immersed in water.

### S2

S2 is a step in which a reduction in pressure inside a reaction container is started. The waste solid-state battery with immersed in the water is placed in the reaction container, and the pressure inside the reaction container is reduced by operating a pump or the like. Note that the timing when the reduction in pressure is started is the same as, for example, the timing when the waste solid-state battery is immersed in the water, or the timing when a predetermined time is elapsed since the waste solid-state battery is immersed in the water. Alternatively, the timing when the reduction in pressure is started can be the timing when the generation of bubbles from the solid-state battery is observed.

### S3

S3 is a step of maintaining a state in which the pressure inside the reaction container is reduced. In S3, the pressure inside the reaction container is maintained at a predetermined value by adjusting the output of the pump, and adjusting the intake valve 241 and the exhaust valve 242, or the like.

### S4

S4 is a step of completing the reduction in pressure inside the reaction container. In S4, the operation of the pump or the like is stopped, and the intake valve 241 is opened, so that the pressure inside the reaction container is set to, for example, the atmospheric pressure.

The timing when the reduction in pressure inside the reaction container is completed can be at any of the following timings. For example, the timing is, for example, the timing when the generation of bubbles from the solid-state battery is completed, the timing when the hydrogen concentration or hydrogen sulfide of the immersion water inside the reaction container reaches a predetermined value, or the timing when a predetermined time is elapsed since the reduction in pressure in S2 is started.

By S4, the positive and negative electrode separation step in the treatment method for a waste solid-state battery of the present embodiment is completed.

One embodiment of the present invention has been described above. The present invention is not limited to the above-described embodiment, and various modifications, variations, and combinations are possible.

For example, in the above description, the generation of bubbles from the lithium metal 12 which is a negative electrode material, and a sulfide solid electrolyte 10 has been described. The present invention can be applied not only when the bubbles are generated from both of the negative electrode material and the solid electrolyte but also when the bubbles are generated from one of the negative electrode material and the solid electrolyte.

In the treatment method for a waste solid-state battery of the present embodiment, at least one selected from the solid electrolyte and the negative electrode material included in the waste solid-state battery is water-soluble. Therefore, when the solid electrolyte is water-soluble, the negative electrode material need not be water-soluble. For example, when the solid electrolyte is the sulfide solid electrolyte 10, the negative electrode material need not be water-soluble. Therefore, the negative electrode material is not limited to the lithium metal 12, and can be, for example, a carbon-based material or a silicon-based material.

A time-varying profile of pressure can be changed in various ways. The time-varying profile of pressure can include, for example, a pressure reduction, pressure retention, and a pressure rise to the atmospheric pressure. The time-varying profile of pressure may include repetition of the pressure reduction and the pressure rise to the atmospheric pressure.

Embodiments of the present invention have been described above. The present invention is not limited to the above-described embodiments, and various modifications, variations, and combinations are possible.

### EXPLANATION OF REFERENCE NUMERALS

10 Sulfide solid electrolyte (solid electrolyte)

12 Lithium metal (negative electrode material)

16 Aluminum foil

18 Copper foil

30 Immersion water (water)

32 Lithium ion

40 Bubble

100 Solid-state battery (electrode assembly)

200 Processing device

210 Pressure container

220 Pressure gauge

231 Intake pipe

232 Exhaust pipe

241 Intake valve

242 Exhaust valve

250 Reaction container

What is claimed is:

1. A treatment method for a waste solid-state battery,
the waste solid-state battery including a solid electrolyte and a negative electrode material, wherein at least one selected from the solid electrolyte and the negative electrode material is water-soluble and generates gas when immersed in water,
the method comprising:
a step of immersing an electrode assembly of the waste solid-state battery in water; and
a step of reducing a pressure of a surrounding environment of the water.

2. The treatment method for a waste solid-state battery according to claim 1, wherein
the solid electrolyte includes at least one selected from a water-soluble sulfide and a water-soluble oxide.

3. The treatment method for a waste solid-state battery according to claim 1, wherein
the negative electrode material includes at least one selected from lithium metal, sodium metal, potassium metal, magnesium metal, calcium metal, a lithium titanium oxide, a carbon material, and silicon.

4. The treatment method for a waste solid-state battery according to claim 1, wherein
the negative electrode material is lithium metal or sodium metal, and
the waste solid-state battery in a state before the negative electrode material is deactivated is immersed in water.
